(19) United States
(12) Patent Application Publication
(10) Pub. No.: US 2019/0211956 A1
(43) Pub. Date: Jul. 11, 2019

(54) Method and Apparatus for Connecting a Hose to a Fitting

(71) Applicant: Larry F. Bobenhausen, St. Petersburg, FL (US)

(72) Inventor: Larry F. Bobenhausen, St. Petersburg, FL (US)

(21) Appl. No.: 15/863,481

(22) Filed: Jan. 5, 2018

(51) Int. Cl. F16L 33/02

(52) U.S. Cl. CPC F16L 33/02

(57) ABSTRACT

A clamp guide for joining a flexible hose to a rigid, hollow shaft were the rigid, hollow shaft has a head bead and two other beads includes an end clamp for interfacing with the head bead and two legs extending from the end clamp. Each of the legs has two bumps. The bumps are aligned with a corresponding bead of the two other beads thereby forming two registration areas, one between the end clamp and a first of the two bumps and another registration area between the two bumps.

### FIELD OF THE INVENTION

This invention relates to a method for connecting a hose to a fitting. More particularly, it refers to a method and apparatus for connecting a hose to a fitting using one or more clamps and using a clamp guide.

### BACKGROUND

Air conditioning hose assembly connection systems are known. The simplest is to fit an end of a flexible, compressible hose over a metal fitting or stem and attaching clamps on the hose over the fitting to hold the hose to the fitting and to prevent leaks in various applications such as with high pressure refrigerants. Often, this is not sufficient for such high pressure connections because the hose tends to slip off the fitting. To improve this type of connection, the fitting is made with one or more beads that help hold the hose to the fitting. Still, in high-pressure applications, it is still possible for the hose to come free from the fitting.

To further improve the connection, guides have been deployed to guide the installation of the clamps such that the clamps situate themselves between the beads, making it even more difficult for the hose to slip off of the fitting.

What is needed is a guide that improves holding force between the hose and the fitting.

### SUMMARY OF THE INVENTION

The invention includes a method of joining a flexible hose to a rigid, hollow shaft. The rigid, hollow shaft has at head bead and at least one other bead. The method includes (a) providing a flexible hose; a first of which is cut at 90 degrees with respect to an axis of the flexible hose; and (b) providing a clamp guide. The clamp guide has an end clamp for interfacing with the fitting on one side of a head bead and having two legs. Each leg is formed or affixed to the end clamp and each of the legs has at least one bump. Each of the at least one bump corresponds to and is aligned with a corresponding bead such that the bumps define registration areas between adjacent bumps/beads. (c) At least one hose clamp is loosely placed over the flexible hose and (d) the clamp guide is installed over the hose with the end clamp on one side of the head bead and the two legs at a distal side of the head bead. (e) The first end of the flexible hose is pushed over the rigid, hollow shaft, thereby abutting a head bead of the at least two beads then (f) the end clamp is tightened. (f) each of the at least one hose clamp is positioned over a corresponding registration areas and (g) tightened, thereby compressing the flexible hose between the at least one beads.

In another embodiment, a method of joining a flexible hose to a rigid, hollow shaft is disclosed. The rigid, hollow shaft has three beads, a head bead, a first bead, and a second bead. The method includes (a) providing a flexible hose, a first end of which is cut at 90 degrees with respect to an axis of the flexible hose and (b) providing a clamp guide. The clamp guide has an end clamp for interfacing with the head bead and two legs. The legs extending from the end clamp. Each of the legs has a first bump aligned with the first bead and a second bump aligned with the second bead thereby forming a first registration area between the end clamp and the first bump and forming a second registration area between the first bump and the second bump. (c) Two hose clamps are loosely placed over the flexible hose and (d) the clamp guide is loosely placed over the flexible hose. (e) The first end of the flexible hose is pushed over the rigid, hollow shaft, the first end of the flexible hose abutting the head bead. (f) The clamp guide is attached by interfacing the end clamp over the head bead and resting the clamp guide legs against the flexible hose. A first hose clamp of the two hose clamps is positioned over the first registration area and a second hose clamp of the two hose clamps is positioned over the second registration area. (i) The end clamp, the first hose clamp, and the second hose clamp are then tightened (e.g. crimped), thereby compressing the flexible hose between the head bead and the first bead and between the first bead and the second bead

In another embodiment, a clamp guide for joining a flexible hose to a rigid, hollow shaft is disclosed. The rigid, hollow shaft has a head bead and two other beads. The clamp guide includes an end clamp for interfacing with the head bead and two legs extending from the end clamp. Each of the legs has two bumps. The bumps are aligned with a corresponding bead of the two other beads thereby forming two registration areas, one between the end clamp and a first of the two bumps and another registration area between the two bumps.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a guide of the prior art.

FIG. 2 illustrates a sectional view of a guide of the prior art.

FIG. 3A illustrates a perspective view of an improved clamp guide.

FIG. 3B illustrate an elevational view of the improved clamp guide.

FIG. 3C illustrates a perspective view of the improved clamp guide.

FIG. 3D illustrates a perspective view of an alternate improved clamp guide.

FIG. 3E illustrates a cut-away view of the alternate improved clamp guide.

FIG. 4 illustrates a perspective view of the improved clamp guide as it attaches to a hose and fitting.

FIG. 5 illustrates a perspective view of the improved clamp guide attached to a hose and fitting before adding clamps.

FIG. 6 illustrates a perspective view of the improved clamp guide attached to a hose and fitting after adding clamps.

FIG. 7 illustrates a perspective view of a hose connecting two fittings using the improved clamp guide and clamps.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

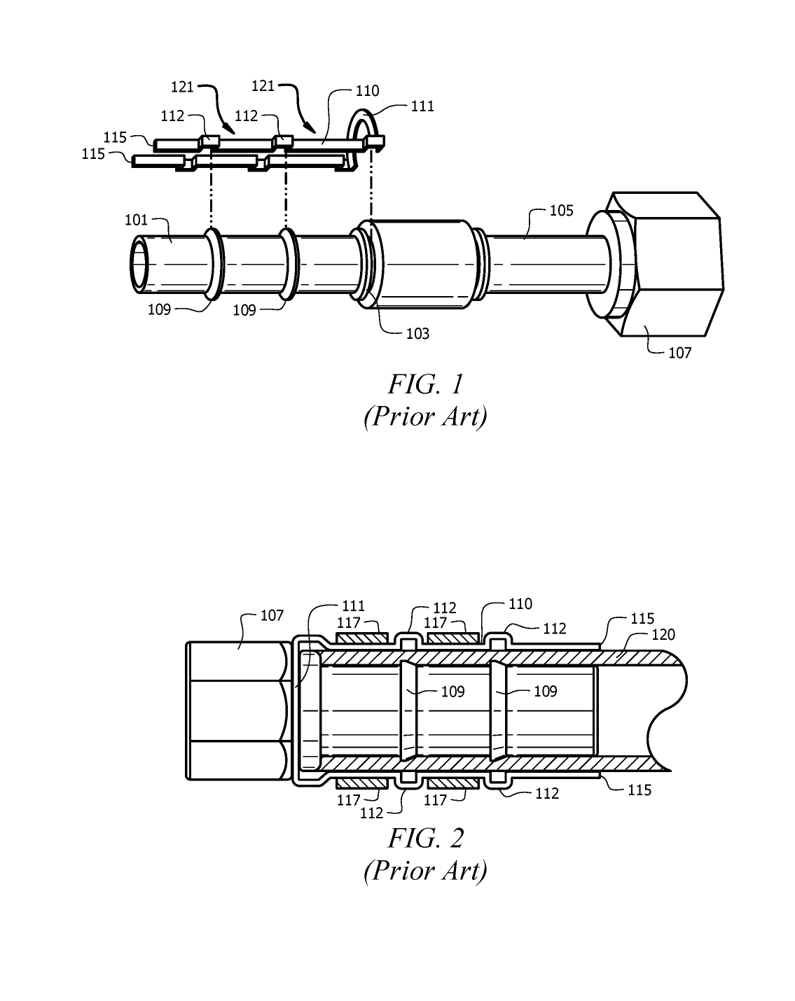

Referring to FIG. 1 and FIG. 2, a perspective view and a plan view of a clamp guide 110 of the prior art is shown. The prior art for connecting a flexible hose 120 to a rigid, hollow shaft 101/105 includes a clamp guide 110 as shown in FIG. 1. The clamp guide 110 has registrations 121 between ridges 112 that align with beads 109 on a hose-connection end 101 of the rigid, hollow shaft 101/105. The clamp guide 110 has a semi-circular portion 111 that fits inside a groove 103 in the rigid hollow shaft 101/105 so that the clamp guide arms 115 are on exactly opposite sides of the flexible hose 120 when the flexible hose 120 is positioned over the receiving end 101 of the rigid, hollow shaft 101/105. The rigid, hollow shaft 101/105 is anticipated to be a component of a variety of connectors and fittings, one example is shown having a threaded fitting 107 at an end 105 distal from where a flexible hose 120 is attached using the clamp guide 110 and clamps 117.

As pressure increases, using the clamp guides 110 and claims 117 of the prior art, the hose 120 tends to pull off of the shaft 101 of the fitting, deforming the clamp guide 110 and skewing the arms 115 of the clamp guide 110 until the hose eventually pulls off of the shaft 101 of the fitting.

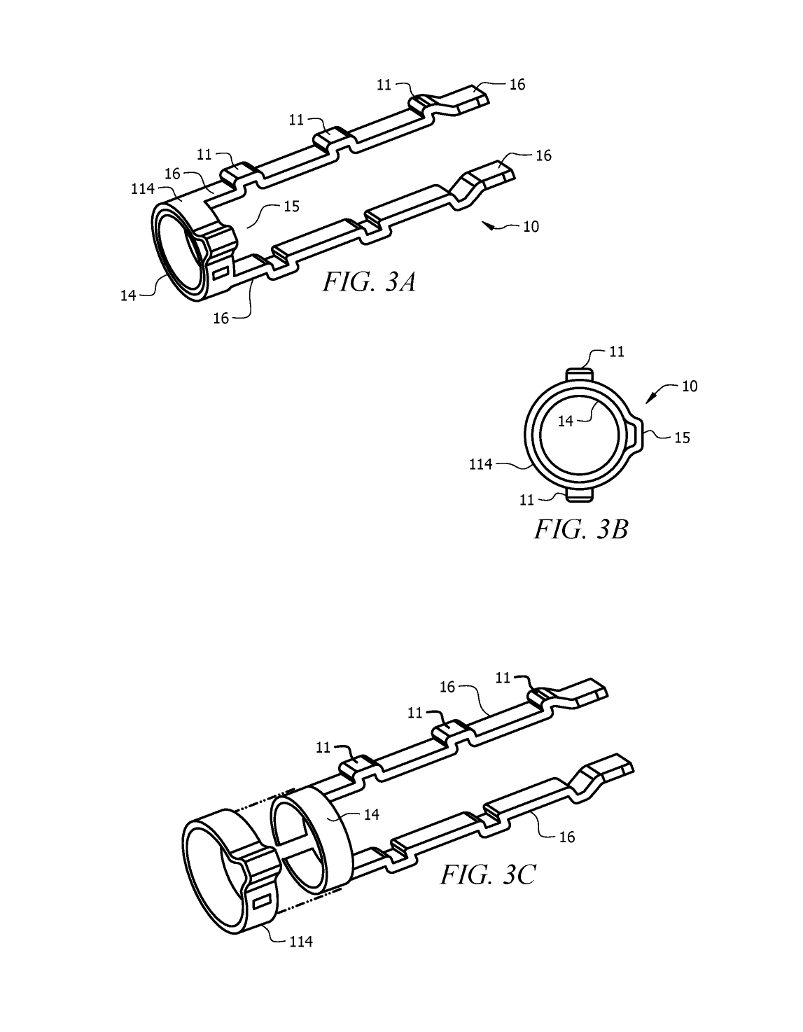

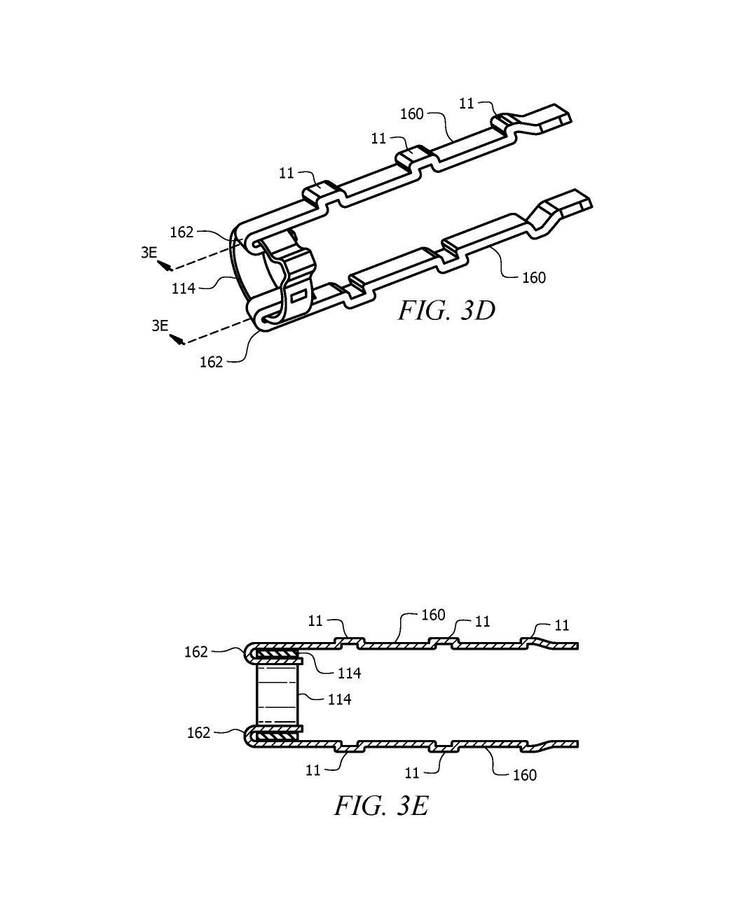

Referring to FIG. 3A-E, views of the improved clamp guide 10 are shown. In FIGS. 3A and 3B, the clamp guide 10 includes two clamp guide arms 16 connected to an end clamp 114, or, as shown in FIG. 3C, the legs 16 are affixed to an inner collar 14 and an end clamp 114 surrounds the inner collar 14. In FIGS. 3A and 3B, an inner collar 14 is optionally provided for spacing purposes.

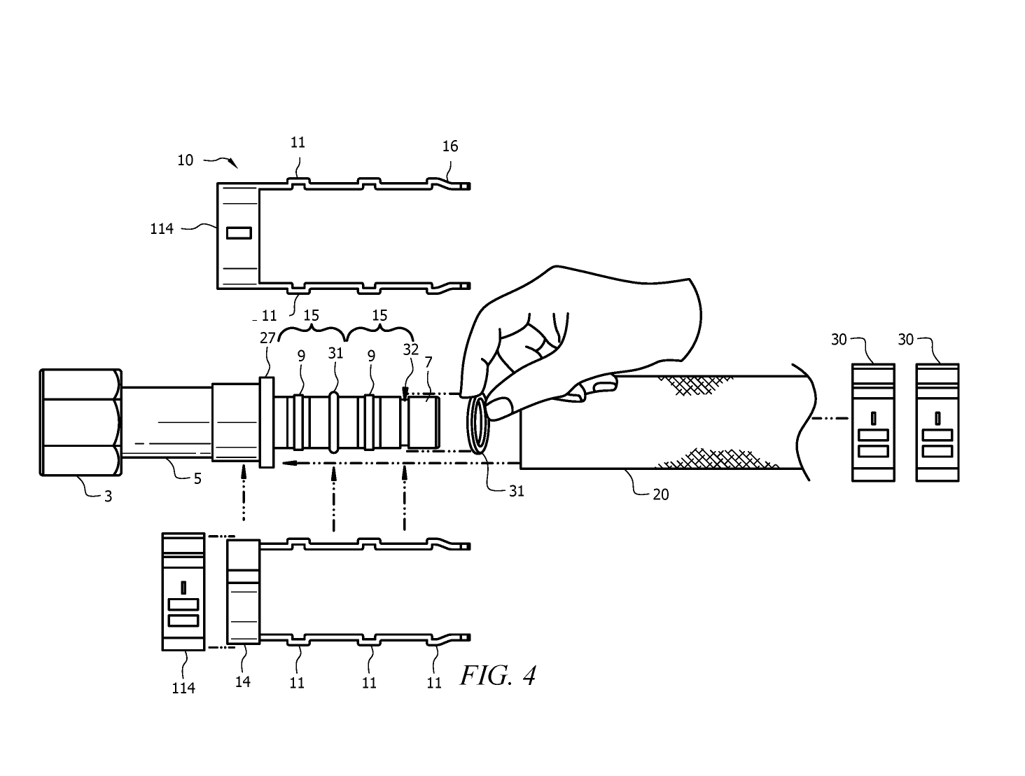

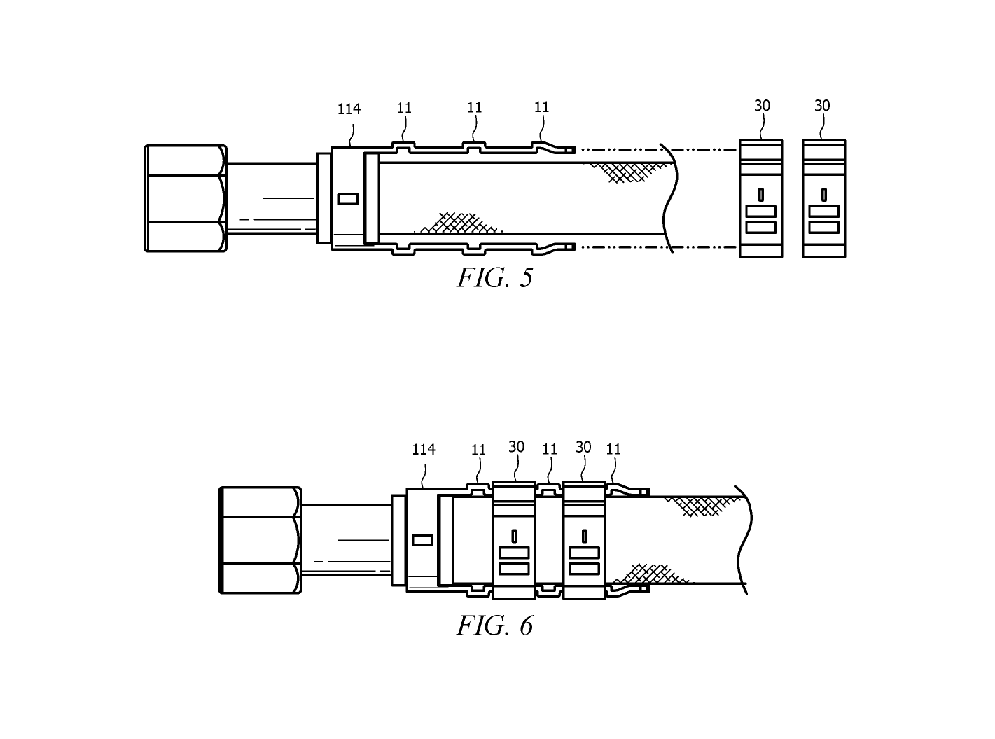

When the clamp guide 10 is installed on a fitting 5 (see FIGS. 4-7), the clamp guide arms 16 rest on the outer surface of a hose 20 (see FIGS. 4-7) that is pushed over an end 7 of the fitting 5. The clamp guide arms 16 have bumps 11, between which are installed one or more clamps 30. The location of the bumps 11 guide an installer to correctly place each clamp 30 so that when the clamps 30 are tightened, the hose 20 is compressed in an area of the end 7 of the fitting 5 at which will provide maximum resistance to the hose 20 pulling away from the fitting 5 (e.g. in a registration area 15 between features 9 of the fitting 5). For some types of hose 20, the location of each clamp 30 is directly above an optional o-ring 31. As the hose clamps 30 (see FIGS. 5 and 6) are tightened around the flexible hose 20, the flexible hose 20 compresses around the rigid hollow shaft 7 of the fitting, deforming the flexible hose 20 slightly in the registration area 15 between the features 9, thereby forming a stronger bond between the fitting/connector 5 and the flexible hose 20. Any known types of hose clamps 30 are anticipated.

The end clamp 114 is clamped behind the head bead 27 (see FIG. 4) and the clamp guide 10 and legs 16 are therefore maintained in relationship to the fitting 5, providing added strength to keep the hose 20 connected to the fitting 5, even under high pressures as experienced in the field of air conditioning. The end clamp 14 holds tightly to a fitting 5 (see FIGS. 4-7) such that an increased amount of burst force is needed to pull the clamp 10 off of the fitting 5, thereby reducing the possibility that the hose 20 will pull away from the fitting 5.

Although not required, in a preferred embodiment, the bumps 11 are wide enough so as to provide clearance in an area over the features 9 (shown clearly in FIG. 4) so as not to overly compress the hose 20 in such location.

The clamp guide arms 16 have bumps 11 that align with the beads 9 (see FIG. 4) and registration areas 15 that are aligned between the beads 9. The hose clamps 30 (see FIG. 5-7) are placed over the clamp guide arms 16 such that the hose clamps 30 seats into the registration areas 15. In this way, as the hose clamps 30 are tightened, the flexible hose 20 is compressed in between the beads 9 at the registration areas 15, providing a stronger connection between the flexible hose 20 and the rigid, hollow shaft 7, thereby resisting separation under high pressure.

Although two registration areas 15 are shown, the present invention is not limited to any particular number of registration areas 15 and any number of registration areas 15 is anticipated including one registration area 15.

It is preferred to fabricate the clamp guide arms 16 from a stiff, sturdy metal such as steel.

In FIGS. 3D and 3E, the alternate legs 160 are formed with bends 162 at one end. The bends 162 are compressed over the end clamp 114 to hold the alternate legs 160 to the end clamp 114, providing the above described resistance from the hose 20 pulling off the fitting 5. Note that although the bend 162 is likely to provide sufficient burst resistance, in some embodiments, an adhesive, compression, or a weld is used to maintain a connection between the alternate legs 160 and the end clamp 114.

Referring to FIG. 4-6, plan views of the present invention as it attaches to a hose is shown. In FIG. 4, the flexible hose 20 is shown cut at 90 degrees and is ready to be pushed over the connection end 7 of the rigid, hollow shaft 5/7. To facilitate connection, two hose clamps 30 are placed loosely over the flexible hose 20, typically before the flexible hose 20 is pushed over the connection end 7. The improved clamp guide 10 is placed over the flexible hose 20, with the end clamp 114 positioned to overlap the head bead 27 of the fitting 5, thereby also aligning the bumps 11 with the beads 9 such that clamps positioned between the bumps 11 will be positioned correctly over the registrations 15 within the spaces between the beads 9.

Also shown is the clamp 10 of FIG. 3A shown positioned in the same way with the end claim 114 over the head bead 27

In FIG. 5, the clamp guide 10 is on the flexible hose 20, and the end clamp 14 is interfaced with the head bead 27 of the fitting 5. The clamps have not yet been positioned over the registration areas 15.

In FIG. 6, the hose clamps 30 are positioned in the registration areas 15 and tightened, thereby forming a strong bond between the flexible hose 20 and the fitting 5. Likewise, the end claim 14 is tightened holding the entire clamp guide 10 in position with respect to the head bead 27 and, therefore, resisting the clamp guide 10 from separating from the fitting 10 and, hence, better holding the hose 20 to the fitting 5, even under high pressures.

Although shown with a fitting 5 with a threaded nut 3 at one end, any type of fitting/connection is anticipated. Further any number of beads 9 and registration areas 15 are anticipated for joining to flexible hoses 20 to fittings, including a single registration area 15. Depending upon the type of hose 20, in some embodiments, o-rings 31 are placed within o-ring grooves 32 of the fitting before placement of the hose over the end 7 of the fitting 5. For other types of hose 20, there are no o-rings 31 placed in o-ring grooves 32 and, in some embodiments, there are no o-ring grooves.

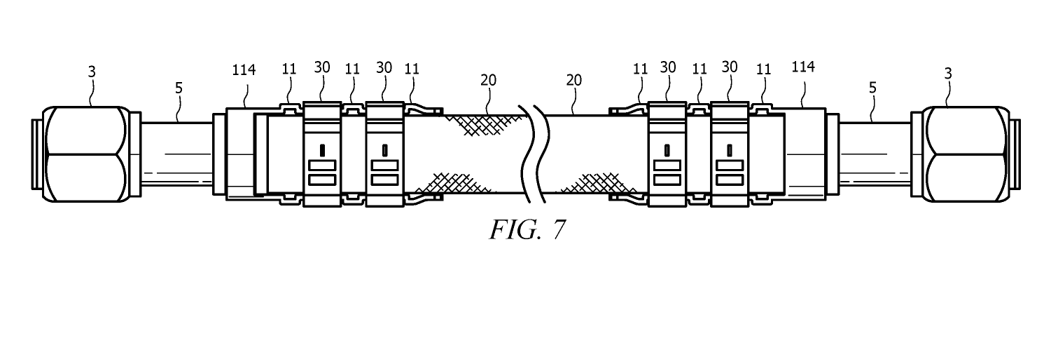

Referring to FIG. 7, of a perspective view of a hose 20 connecting two fittings using the improved clamp guide 10 and clamps 30 is shown. The hose clamps 30 are positioned in the registration areas 15 and tightened, thereby forming a strong bond between the flexible hose 20 and the end portion 7 of the fitting 5. Again, any type of fitting/connection 3 is anticipated as well as any number of beads 9 for joining to flexible hoses 20. The clamps 30 are positioned and held between the bumps 11. As the clamps 30 are tightened, the clamps 30 apply pressure over the registration areas 15 compress the hose 20 in an area between the beads 9/22 (not visible in FIG. 7).

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of joining a flexible hose to a rigid, hollow shaft of a fitting, the rigid, hollow shaft having at head bead and at least one other bead, the steps comprising:
(a) providing a flexible hose, a first end of the flexible hose cut at 90 degrees with respect to an axis of the flexible hose;
(b) providing a clamp guide, the clamp guide having an end clamp for interfacing with the fitting on one side of a head bead, the clamp guide having two legs, each leg is formed or affixed to the end clamp, each of the legs having at least one bumps, each of the at least one bump corresponding to and aligned with a corresponding bead, the bumps defining registration areas between adjacent bumps;
(c) placing at least one hose clamp loosely over the flexible hose;
(d) installing the clamp guide with the end clamp on one side of the head bead and the two legs at a distal side of the head bead;
(e) pushing the first end of the flexible hose over the rigid, hollow shaft, the first end of the flexible hose abutting a head bead of the at least two beads;
(f) tightening the end clamp;
(f) positioning each of the at least one hose clamp over a corresponding registration areas; and
(g) tightening each of the at least one hose clamp, thereby compressing the flexible hose between the at least one beads.

2. The method of claim 1, wherein the at least two beads is exactly two beads, the at least two bumps is exactly two bumps and the registration areas is exactly one registration area.

3. The method of claim 1, wherein the at least two beads is exactly two beads, and the registration areas is exactly two registration areas, a first registration area between the head bead and a first bead of the two beads and a second registration area between the first bead of the two beads and a second bead of the two beads.

4. The method of claim 1, wherein the rigid, hollow shaft further includes at least one o-ring groove between the at least two beads and each of the at least one o-ring grooves is fitted with an o-ring.

5. The method of claim 1, where the rigid, hollow shaft is part of a threaded fitting.

6. The method of claim 1, wherein the clamp guide is stamped and formed from a sheet of steel.

7. A method of joining a flexible hose to a rigid, hollow shaft, the rigid, hollow shaft having three beads, a head bead, a first bead, and a second bead, the steps comprising:
(a) providing a flexible hose, a first end of the flexible hose cut at 90 degrees with respect to an axis of the flexible hose;
(b) providing a clamp guide, the clamp guide having an end clamp for interfacing with the head bead, the clamp guide having two legs, the legs extending from the end clamp, each of the legs have a first bump aligned with the first bead and a second bump aligned with the second bead thereby forming a first registration area between the end clamp and the first bump and forming a second registration area between the first bump and the second bump;
(c) placing two hose clamps loosely over the flexible hose;
(d) placing the clamp guide loosely over the flexible hose;
(e) pushing the first end of the flexible hose over the rigid, hollow shaft, the first end of the flexible hose abutting the head bead;
(f) attaching the clamp guide by interfacing the end clamp over the head bead and resting the clamp guide legs against the flexible hose;
(g) positioning a first hose clamp of the two hose clamps over the first registration area;
(h) positioning a second hose clamp of the two hose clamps over the second registration area; and
(i) tightening the end clamp, the first hose clamp, and the second hose clamp, thereby compressing the flexible hose between the head bead and the first bead and between the first bead and the second bead.

8. The method of claim 7, wherein the hollow shaft further includes at first o-ring groove between the first bead and the second bead and the first o-ring groove is fitted with a first o-ring.

9. The method of claim 7, wherein the hollow shaft further includes at second o-ring groove between the head bead and the first bead and the second o-ring groove is fitted with a second o-ring.

10. A clamp guide for joining a flexible hose to a rigid, hollow shaft, the rigid, hollow shaft having a head bead and two other beads, the clamp guide comprising:
an end clamp for interfacing with the head bead; and
two legs extending from the end clamp, each of the legs have two bumps, the bumps being aligned with a corresponding bead of the two other beads thereby forming two registration areas, a first registration area between the end clamp and a first bump of the two bumps and a second registration area between the two bumps.

11. The clamp guide of claim 10, wherein the rigid, hollow shaft further includes at least one o-ring groove between the two other beads and each of the at least one o-ring grooves is fitted with an o-ring.

12. The clamp guide of claim 10, where the rigid, hollow shaft is part of a threaded fitting.

13. The clamp guide of claim 10, wherein the clamp guide is stamped and formed from a sheet of steel.

14. The clamp guide of claim 10, wherein the two legs are formed as a continuous piece of metal, continuing from the end clamp.

15. The clamp guide of claim 10, wherein the two legs are welded to the end clamp.

16. The clamp guide of claim 10, wherein an end of each of the two legs is bent around the end clamp.

17. The clamp guide of claim 17, wherein the end of each of the two legs includes an adhesive there the end of each of the two legs is bent around the end clamp.
